(19) United States
(12) Patent Application Publication
(10) Pub. No.: US 2006/0093311 A1
(43) Pub. Date: May 4, 2006

(54) Device for directly playing audio and video information from computer storage device

(76) Inventor: Tsung-Yung Hung, Taipei (TW)

Correspondence Address: LIN & ASSOCIATES INTELLECTUAL PROPERTY, P.O. BOX 2339, SARATOGA, CA, 95070-0339, US

(21) Appl. No.: 10/978,257

(22) Filed: Oct. 30, 2004

(51) Int. Cl. H04N 5/76; H04N 11/00; H04N 7/00

(52) U.S. Cl. 386/46; 348/552

(57) ABSTRACT

A device built in a computer for directly playing AV information stored in the computer's storage device without powering on the computer is provided. The AV information is presented on the computer's image display device (such as LCD) and audio device (such as speakers). The AV information could also be presented on external video devices (such as TV, projector) and audio devices (such as stereo) via the computer's built-in video and audio output interfaces. The device could be controlled by control buttons located on the computer's casing or by a remote control.

### BACKGROUND OF THE INVENTION

1. Field of the Invention

The present invention generally relates to audio and video (AV) playing devices and, more particularly, to the devices built in a computer that can directly play AV information stored in the computer's storage device without powering on the computer.

2. The Prior Arts

As digital encoding techniques such as MP3 and MPEG are continuously evolving, more and more analog AV information is digitized, transmitted, and stored. There is, therefore, a tremendous amount of digitized AV information exchanged every day on the Internet and stored as files in computers. As such, computers have also evolved from a number crunching device to a multimedia center capable of playing these digitized AV files.

To play these AV files stored in its storage devices, a computer first has to be powered on and its operating system has to be booted up. Then, a user locates the AV files via the computer's human-machine interface (such as display, keyboard, and mouse), and activates the appropriate playing program. The user then can view and listen to the content of the AV files on the computer's display and through its speakers. This is a lengthy and time-consuming process. In addition, when finishing viewing and listening to the AV files, the user has to follow similar lengthy process to shut down the computer. Therefore, a need for turning computers into home appliances that can be turned on and off instantly has arisen.

In addition, as various novel computer storage devices are widely adopted, AV information is now stored in memory cards (such as those used for storing still images taken by digital cameras or those for storing MP3 music), laser disks (such as VCD, DVD, or music CD), hard disk drives (for storing AV files downloaded from the Internet). If these AV information can be directly played from these storage devices without the lengthy computer power-on procedure, valuable time can be saved and computers would be become a convenient AV playing device, saving the cost for purchasing additional AV equipment. Besides, as notebook computers are gaining popularity, by equipping notebook computers with such capability of directly playing the AV information, notebook computers would become mobile media centers, making such a capability even more powerful.

### SUMMARY OF THE INVENTION

Accordingly, a major objective of the present invention is to provide a device built in a computer capable of directly playing AV information stored in the computer's hard disk drives and other storage devices without powering on the computer.

The device draws its power from the computer's power supply. If the computer (such as a notebook computer) has a battery, the device could also draw its power from the battery, if the computer's power supply is not able to function (for example, when there is a black-out or when the power cord is not plugged in).

The device is designed to access storage devices fixedly installed inside the computer and those non-fixed, external storage devices (such as USB flash drive and USB-based external hard disk) connected to the computer via interfaces such as USB, 1394, parallel port, serial port, etc. The fixed storage devices supported by the present invention are those installed inside the computer. These fixed storage devices could have static storage media (such as hard disk) or removable storage media (such as memory card, floppy disk, laser disk, etc.)

The AV signal played by the device could be presented on the computer's display (such as the built-in LCD display of a notebook computer, or an external display connected to the computer via a VGA cable) and speakers. The AV signal could also be presented on a TV and/or stereo connected to the computer via the computer's video output interface (such as the video-out terminal) and audio output interface (such as the earphone terminal, line-out terminal), if these interfaces are available from the computer.

The device provides multiple control buttons on the computer's casing as the device's human-machine interface. The device could also provide a remote control to operate the device from a distance via an air interface (such as infrared or Bluetooth protocol). Both the remote control and the computer casing could further have a small display (such as LEDs or LCD display) for showing operation status of the device.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

FIG. 1 is a schematic diagram of a common computer's internal structure.

FIG. 2 is a schematic diagram of a computer's internal structure according to the present invention.

### DETAILED DESCRIPTION OF THE PREFERRED EMBODIMENTS

In the following, detailed description along with the accompanied drawings is given to better explain preferred embodiments of the present invention. Please be noted that, in the accompanied drawings, some parts are not drawn to scale or are somewhat exaggerated, so that people skilled in the art can better understand the principles of the present invention.

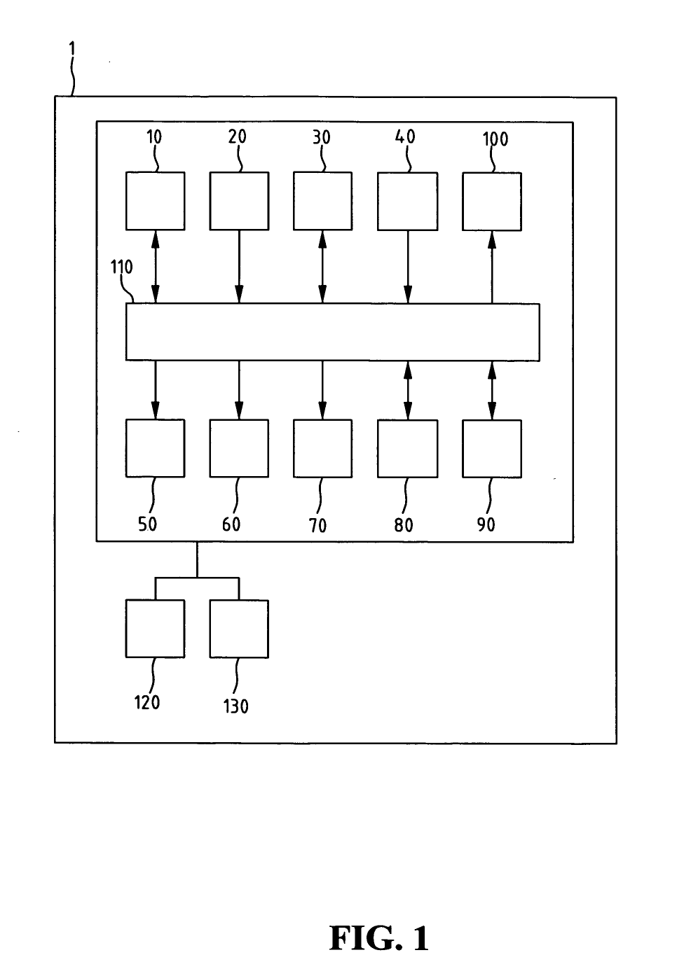

FIG. 1 is a schematic diagram of a common computer's internal structure. As shown in FIG. 1, the computer 1 comprises a processor 10 for handling the computer 1's major computational work. The read-only memory (ROM) 20 contains the BIOS firmware (not shown) providing the lowest level control functions for the computer 1. The random-access memory (RAM) 30 is for storing the codes, variables, and user data generated during the computational process of the operating system and application programs. The input devices 40 such as keyboard, mouse, track-ball are for accepting user input. The image display device 50 is the display connected to the computer 1's VGA port (not shown). The image display device 50 could be a built-in LCD display (if computer 1 is a notebook computer) or a LCD display, a CRT display, or a projector (not shown) connected via a VGA cable. The audio device 60 is the computer 1's built-in speakers or other loudspeakers. What is depicted in FIG. 1 is a notebook computer.

The video output interfaces 70 are for delivering the computer 1's video signal to external video devices. The video output interfaces 70 include, but not limited to, the video-out terminal, S-video terminal, RGB terminals, DVI port, and a second VGA port, etc. These interfaces could be used to connect devices such as (but not limited to) a TV, video recording machine, or projector, etc. The audio output interfaces 80 are for delivering the computer 1's audio signal to external audio devices. The audio output interfaces 80 include, but not limited to, the line-out terminal, earphone terminal, etc. These interfaces could be used to connect devices such as, but not limited to, a stereo, audio recording machine, etc.

The fixed storage devices 90 are storage devices fixedly installed inside the computer 1. There are two types of fixed storage devices: those with static storage media (such as hard disk drives) and those with removable storage media (such as a floppy disk drive, read-only laser disk drive for reading CD-ROM and DVD-ROM disks, read-writable laser disk drive for accessing CD-RW, DVD-RW, DVD+RW disks. A built-in card reader for accessing memory cards (such as MS, SD cards) is also a fixed storage device.

In addition, the computer 1 also contains non-fixed storage devices 100. These external storage devices (such as USB flash drive, USB-based external hard disk, etc.) are connected to the computer 1 via USB, 1394, parallel port, or serial ports, etc. Both the fixed and non-fixed storage devices are supported by the device of the present invention.

Within these storage devices, some have their stored information arranged in a hierarchical directory structure (such as the files in a hard disk drive). AV information in these devices is stored as files within this directory structure. For music or audio files, the file format could be, but not limited to, one of the following: MP3, WAV, MIDI, etc. For still image files, the file format could be, but not limited to, one of the following: JPEG, TIFF, etc. For video files, the file format could be, but not limited to, Motion JPEG, MPEG, etc. There are also some storage devices whose storage media is of some specific format, such as DVD and VCD disks.

The aforementioned parts of the computer 1 are all connected to a bus 110 for exchanging all sorts of data. Please be noted that quite a few details are omitted in FIG. 1 such as the chipsets, I/O controllers, and communication interfaces (such as LAN ports). However, these details are not of much help in explaining the principles behind the present invention and, therefore, they are omitted here for simplicity sake.

The power supply 120 provides the required electrical power to all the aforementioned parts. The power supply 120 receives an AC voltage from the mains and converts it into various DC voltages required by the aforementioned parts of the computer 1. If the computer 1 is a notebook computer, it could also contain a battery 130 for continuously supplying power when there is a black-out or when the AC voltage from the mains is not available. The electrical connections from the power supply 120 and the battery 130 to the various parts of the computer 1 are not depicted in FIG. 1.

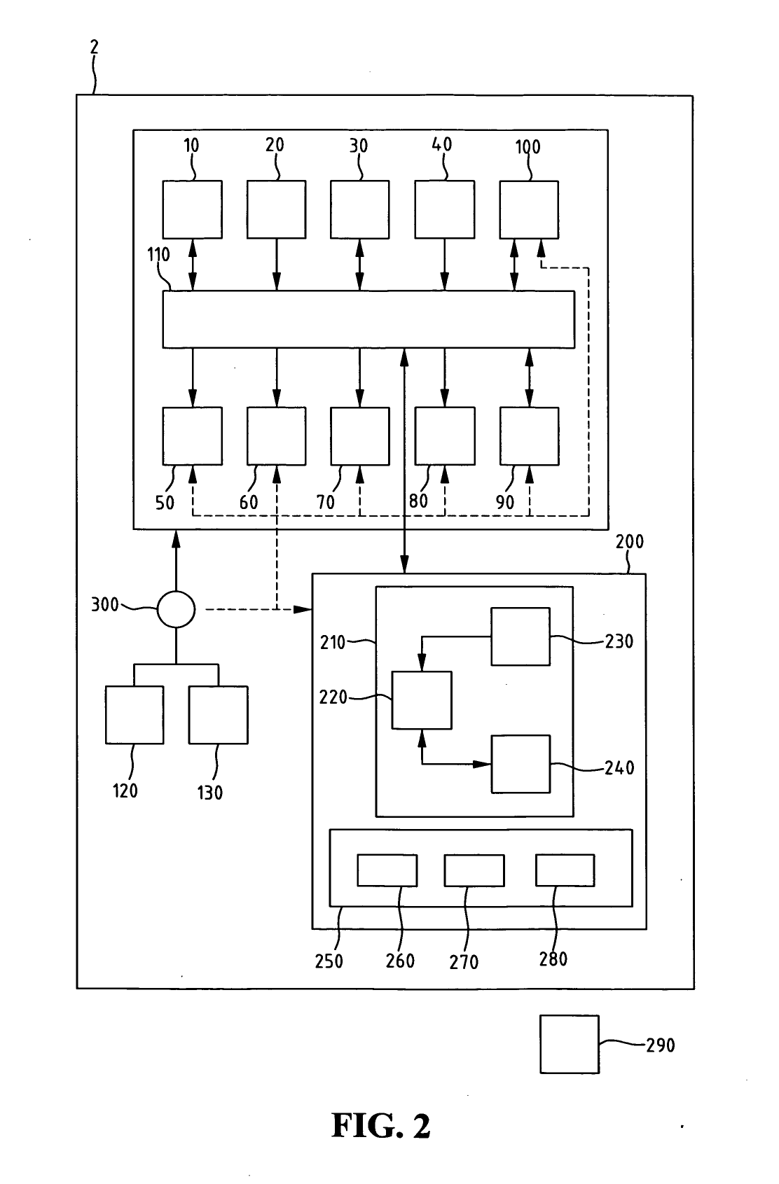

FIG. 2 is a schematic diagram of a computer's internal structure according to the present invention (FIG. 2 also uses a notebook computer as an example). Compared to what is depicted in FIG. 1, the computer 2 according to the present invention has an additional AV playing module 200, which is connected to the bus 110 as well. Through the bus 110, the AV playing module 200 is able to access the AV files or storage media having specific formats in the fixed or non-fixed storage devices. Also through the bus 110, the AV signal decoded by the AV playing module 200 is presented on the image display device 50 and the audio device 60, or on the external AV equipment connected to the video output interface 70 and the audio output interface 80.

The AV playing module comprises a processing chipset 210 and a control interface 250. The processing chipset 210 in turn comprises a microprocessor 220 having AV decoding capability, a ROM 230, and a RAM 240. The microprocessor 220 accesses the AV files or the specially formatted media storage in the storage devices, decodes them, and presents their content on the image display device 50 and the audio device 60, or on the external AV equipment via the video and audio output interfaces 70, 80. The ROM 230 contains the firmware required by the microprocessor 220 for carrying out various tasks. The RAM 240 provides the temporary storage space required by the microprocessor 220 during its operations.

The control interface 250 is for controlling the microprocessor 220's operations. The control interface 250 comprises a set of control buttons 260 located on the casing of the computer 2, through which a user is able to control microprocessor 220's operations. The set of control buttons 260 contains multiple buttons for turning on/off the AV playing module 200's operations (by controlling whether to supply power to the microprocessor 220), selecting the fixed or non-fixed storage devices to access, selecting the output devices or interfaces, play/stop, pause/resume, forward, jump to the beginning, backward, jump to the end, etc.

The control interface 250 could further comprise a small display 270 (such as a LCD screen for showing 10×2 characters) besides the set of control buttons 260. During the operations of the control interface 250, the display 270 provides relevant operation status to a user, such as the name of the file being played, error messages, etc. The control interface 250 could also provide a remote control reception interface 280 for taking commands to the AV playing module 200 from a remote control 290 via infrared or Bluetooth protocol. The remote control 290 basically possesses a same set of control buttons as 260. The remote control 290 could also have a small display for showing operation status.

A major feature of the present invention is that AV information could be played even when the computer 2 is not powered on. The present invention therefore provides a specially designed switch 300 located on the electrical path from the power supply 120 and the battery 130 to the various parts of the computer 2 and the AV playing module 200. The switch 300 is coupled to the power switch (not shown) of the computer 2. When the power switch of the computer 2 is turned on, the switch 300 would be set to a state so that electrical power is delivered to the various parts of the computer 2, but not to the AV playing module 200. As such, when the computer 2 is running, the AV playing module 200 is unable to function due to the lack of electrical power. However, when the computer 2's power switch is off, the switch 300 is set to another state so that the electrical power is delivered to the AV playing module 200, but not to the other parts of the computer 2. In other words, the AV playing module 200 and the other parts of the computer 2 cannot function at the same time. Please be noted that, during the operation of the AV playing module 200, the AV playing module 200 needs to work with the following parts of the computer 2: the bus 110, fixed storage devices 90, non-fixed storage devices 100, video output interfaces 70, audio output interfaces 80, image display device 50, and audio device 60. Therefore, when the AV playing module 200 is supplied with electrical power, there are other electrical paths from the power supply 120 and the battery 130 to the aforementioned parts (shown as dotted lines in FIG. 2), so that these parts are still functioning even though the computer 2 is not powered on. During the operation of the AV playing module 200, if the computer 2's power switch is turned on, the AV playing module 200 would stop immediately as its electrical power is interrupted.

An implementation detail worth of mentioning is that, for those AV files stored in a directory structure, as it is inconvenient to locate a specific AV file using limited control buttons in the complex directory structure, the present invention requires that the AV files have to be in a specific location (such as the root directory) in order to be played. A user could use the set of control buttons 260 to skip the AV files that are not of interest until the one of interest is reached.

The AV playing module 200 of the present invention would automatically determine the appropriate playing modes without user intervention, based on the format of the AV information (such as MP3 music, MPEG movies, etc.)

A basic operation flow of the present invention is as follows. Initially, the power switch of the computer 2 is off. At this moment, the AV playing module 200 is supplied with electrical power. Then the control buttons 260 on the computer 2's casing or the remote control 290 is used to turn on the microprocessor 220, causing it to enter a stand-by mode. The laser disk or the memory card to be played is then inserted into the laser disk drive or the card reader (if it is an AV file to be played from the hard disk driver, this step could be skipped). The control buttons 260 or the remote control 290 is used again to select a storage device to read, the AV file to play, and the output devices or interfaces. Then a play button within the control buttons 260 or on the remote control 290 is used to start the playing. Other operation flows such as stopping AV playing module and selecting a separate fixed or non-fixed storage device to read could be easily understood and, therefore, their description is omitted here.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A device built in a computer capable of directly playing an AV information stored in a storage device of said computer, comprising:
an AV playing module inside said computer connected to a bus of said computer through which data is exchanged with other parts of said computer, said AV playing module accessing an AV information stored in one of said computer's storage devices via said bus, determining a playing mode based on said AV information's format, and delivering said AV information via said bus to at least one of said computer's video output interfaces, audio output interfaces, image display device, and audio device; and
a switching device located on an electrical path through which a power source of said computer supplies electrical power to various parts of said computer and said AV playing module, said switching device coupled with a power switch of said computer so that, when said power switch is turned on, said switching device is set to a state causing said power source to supply electrical power to various parts of said computer other than said AV playing module, and, when said power switch is turned off, said switching device is set to another state causing said power source to supply electrical power only to said AV playing module, said bus, said storage devices, said video output interfaces, said audio output interfaces, said image display device, and said audio device.

2. The device according to claim 1, wherein said image display device is a display built in said computer.

3. The device according to claim 1, wherein said image display device is an external display connected to said computer via a cable.

4. The device according to claim 1, wherein said audio device is said computer's built-in speakers.

5. The device according to claim 1, wherein said video output interfaces comprise at least one selected from the group comprising video-out terminal, S-video terminal, RGB terminals, DVI port, and a second VGA port.

6. The device according to claim 1, wherein said audio output interfaces comprise at least one selected from the group comprising line-out terminal and earphone terminal.

7. The device according to claim 1, wherein said storage devices are fixedly installed inside said computer and comprise at least one selected from the group comprising hard disk drive, read-only laser disk drive, read-writable laser disk drive, and card reader for reading and writing memory cards.

8. The device according to claim 1, wherein said storage devices are external devices connected to said computer via a transmission interface and a cable, said storage devices comprising at least one selected the group comprising flash drive, external hard disk drive, read-only laser disk drive, read-writable laser disk drive, and card reader for reading and writing memory cards.

9. The device according to claim 8, wherein said transmission interface is selected from the group comprising USB, 1394, and parallel port.

10. The device according to claim 1, wherein said AV information is a file stored in a hierarchical directory structure of said storage devices.

11. The device according to claim 1, wherein said AV information is a storage media having a specific format in said storage devices.

12. The device according to claim 1, wherein said power source is a power supply built in said computer.

13. The device according to claim 12, wherein said power source further comprises a battery built in said computer providing its stored electrical power when said power supply cannot function.

14. The device according to claim 1, wherein said AV playing module further comprises:
a processing chipset connected to said bus for accessing, decoding, and playing said AV information; and
a control interface providing an user interface for controlling said processing chipset's operations.

15. The device according to claim 14, wherein said processing chipset further comprises:
a microprocessor connected to said bus for accessing and decoding said AV information stored in said storage devices, and playing said AV information on at least one of said image display device, said audio device, said video output interfaces, and said audio output interfaces;
a ROM storing a firmware required by said microprocessor to carry out various tasks; and
a RAM providing temporary storage space during said microprocessor's computing process.

16. The device according to claim 14, wherein said control interface further comprises a set of control buttons located on a casing of said computer providing at least the following functions: turning on/off said AV playing module, selecting a storage device to access, selecting at least one of said output devices and interfaces for playing said AV information, selecting said AV information, playing/stopping, pausing/resuming, jumping forward, jumping backward, jumping to a start position, and jumping to an end position.

17. The device according to claim 16, wherein said control interface further comprises a display on said casing of said computer besides said set of control buttons for showing operation status of said AV playing module to a user during said control interface's operation process.

18. The device according to claim 16, wherein said control interface further comprises a remote control reception interface on said casing of said computer and a remote control providing at least a same set of functions as those provided by said set of control buttons, through which said AV playing module is controlled in a distance via a form of wireless communication.

19. The device according to claim 18, wherein said remote control further comprises a display for showing operation status.

20. The device according to claim 10, wherein said AV information is stored at a specific location within said hierarchical directory structure.
